(19) United States
(12) Patent Application Publication
(10) Pub. No.: US 2026/0058961 A1
(43) Pub. Date: Feb. 26, 2026

(54) BOT DETECTOR

(71) Applicant: Target Brands, Inc., Minneapolis, MN (US)

(72) Inventors: Amy Duda, St. Paul, MN (US); Akash Agarwal, Bengaluru (IN); Scott Zuehlke, Minneapolis, MN (US); Varsha Shiva Kumar, Bengaluru (IN); Ryan Siskind, Minneapolis, MN (US); Yujin Lee, Rochester, MI (US); Manasa Potnuru, Sunnyvale, CA (US)

(21) Appl. No.: 18/810,744

(22) Filed: Aug. 21, 2024

(51) Int. Cl. H04L 9/40

(52) U.S. Cl. CPC H04L 63/1416

(57) ABSTRACT

A bot detector is disclosed. The bot detector can apply one or more subsystems for detecting bots. The subsystems may include one or more of a system for identifying self-identified bots, a system for applying one or more rules to identify bots, or a system for identifying bots based on outlier activity. The system for identifying bots based on outlier activity may include one or more outlier detection models that determine whether a user is an outlier based on features of activity data associated with a website.

### BACKGROUND

Some activity at a website or other application may be associated with bots. It may be beneficial to distinguish which activity comes from bots and which activity comes from humans. It may be challenging, however, to identify bots. In some instances, the amount of activity on certain websites or networks, such as the internet, may make it challenging to distinguish between bots and humans. Furthermore, some bots may not identify themselves as bots or may attempt to hide their identities as bots, thereby exacerbating the challenge of determining which activity corresponds to bots and which activity corresponds to humans.

### SUMMARY

In general terms, aspects of the present disclosure relate to a bot detector. The bot detector may analyze activity data to determine which users in the activity data are bots. The bot detector may use a combination of approaches for detecting bots. For example, the bot detector may identify self-identified bots, the bot detector may identify bots using a set of rules, and the bot detector may detect bots based on outlier behavior.

In a first aspect, a method for detecting bots is disclosed. The method comprises receiving activity data associated with a website; identifying a first set of bots in the activity data by identifying self-identifying bots; identifying a second set of bots in the activity data by applying one or more rules for identifying bots; and identifying a third set of bots in the activity data by identifying outlier activity.

In a second aspect, a method for detecting bots based on outlier activity is disclosed. The method comprises receiving activity data associated with a website, the activity data including a plurality of users; identifying a plurality of features; inputting the activity data into a first model to generate a first score for each user of the plurality of users, wherein the first model determines center values for the plurality of features and generates the first score for each user based on distances of feature values for the user from the center values for the plurality of features; inputting the activity data into a second model to generate a second score for each user of the plurality of users, wherein the second model clusters the plurality of users and generates the second score for each user based on a distance of the user from a center of a cluster to which the user is assigned; for each user of the plurality of users, aggregating the first score and the second score for the user to determine whether the user is an outlier; and for each user of the plurality of users, in response to determining that the user is an outlier, classifying the user as a bot.

In a third aspect, a system for detecting bots is disclosed. The system comprises a website; an activity detector configured to determine activity data associated with the website; and a bot detector; wherein the bot detector includes a processor and memory storing instructions, wherein the instruction, when executed by the processor, cause the bot detector to: identify a first set of bots in the activity data by identifying self-identifying bots; identify a second set of bots in the activity data by applying one or more rules for identifying bots; and identify a third set of bots in the activity data by identifying outlier activity.

### BRIEF DESCRIPTION OF THE DRAWINGS

FIG. 1 illustrates an example network environment in which aspects of the present disclosure may be implemented.

FIG. 2 illustrates a block diagram of an example architecture of aspects of an information system.

FIG. 3 illustrates a block diagram of an example architecture of aspects of a bot detector.

FIG. 4 is a flowchart of an example method for detecting bots.

FIG. 5 illustrates a block diagram of example components of a self-identified bot detector.

FIG. 6A illustrates example data associated with a rules-based bot detector.

FIG. 6B illustrates example data associated with a rules-based bot detector.

FIG. 7 is a flowchart of an example method for identifying features.

FIG. 8 is a flowchart of an example method for identifying outlier bots.

FIG. 9 is a flowchart of aspects of an example method for identifying outlier bots.

FIG. 10 illustrates an example user interface associated with a bot detector.

FIG. 11 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In example aspects, a bot detector analyzes data of users of a website to identify which users are bots. In some embodiments, the bot detector uses multiple approaches to identify bots. For example, the bot detector may identify self-identified bots, the bot detector may apply rules to identify bots, and the bot detector may identify users with outlier behavior as bots.

In example aspects, regarding self-identified bots, when a user requests a webpage from a website, the user may send a user agent string, which includes information about the user's browser, operating system, and other data. Some users may identify themselves as bots by including a keyword in the user agent string, such as “Googlebot” or “crawler.” Thus, to identify theses self-identifying bots, the bot detector may perform string matching to determine whether the user agent string includes any keywords in a list of keywords associated with self-identifying bots. In some embodiments, the bot detector may apply a machine learning model to detect self-identified bots by analyzing text in user agent strings.

In example aspects, regarding rules-based bot identification, the bot detector may apply rules to identify bots. An example rule may be to classify users from certain IP addresses or users with certain user agent strings as bots based on metrics associated with users from those IP addresses or user agent strings. The bot detector may also apply other rules or combinations of rules to detect bots.

In example aspects, regarding outlier detection, the bot detector identifies users with anomalous behavior as bots. To do this, the bot detector may identify or define features of user behavior. Example features may include the following: whether the user has an ID associated with the website; certain actions taken by the user; the average visit time; the number of pages viewed; the number of non-character search terms; the depth of navigation of the website; the number of null previous page views; or other features, as described further herein. Using these features, the bot detector may use one or more models to identify anomalous behavior. The one or more models may include at least one statistical model and at least one clustering model. As an example, the one or more models may include a Z-Score model, an Interquartile Range (IQR) model, or a K-Means model. When using these models, the bot detector may exclude certain classes of users (e.g., single-page users), which may otherwise skew the data.

In example aspects, for the Z-Score model and the IQR model, the bot detector may identify anomalous behavior based on activities that are sufficiently far from a center value (e.g., a mean or median) for a given feature. If such deviation is detected, then that feature is flagged. For the K-Means model, if the user is sufficiently far from the center of the cluster to which it is assigned (e.g., in the 99th percentile for its distance from the center), then that user is flagged for the K-Means model. The bot detector may assign weights to the outputs of the models and aggregate the weighted outputs. Using this output, the bot detector may determine whether the user is a bot.

In example aspects, the bot detector can, for a set of data representing user activity, output whether each user corresponds with a bot. Depending on how a bot is identified, the bot detector may classify the bot as a self-identified bot, a rules-based bot, or an outlier bot. For outlier bots, the bot detector may further provide a bot confidence score generated by the one or more models, and the bot confidence score may correspond to a likelihood that the user is a bot.

Aspects of the present disclosure provide various technical advantages. One such advantage may be a more accurate recognition of bots. For example, by using a combination of approaches to detect bots, the bot detector may detect bots that otherwise may not have been identified as bots in previous systems. Furthermore, when the bot detector identifies a user as a bot, the likelihood is increased that the user is, in fact, a bot. In some embodiments, by improving the accuracy of bot detection, the effectiveness of other digital systems, such as security and analytics systems, may likewise be improved.

In some embodiments, a further advantage of aspects of the present disclosure may be a bot detector that provides more information in addition to a binary classification of whether a user is a bot. For example, the bot detector may, for a user classified as a bot, identify which of a plurality of bot detector subsystems identified the bot, thereby providing data regarding characteristics of the bot and whether it is harmful or helpful to an information system. Yet still, in some embodiments, the bot detector may provide a confidence level associated with its detection, thereby providing further insight into bot characteristics and enabling a selection of a sensitivity in the classification of bots. Yet still, in some embodiments, the bot detector may be modular, thereby providing flexibility regarding how the bot detector is implemented. For example, bot detector subsystems of the bot detector may be selectively activated and deactivated. As a result, based on one or more of computer resource constraints or use case-specific performance requirements, different subcomponents of the bot detector may be activated or deactivated. As will be apparent to those having skill in the art, these are only some examples of advantages offered by aspects of the present disclosure.

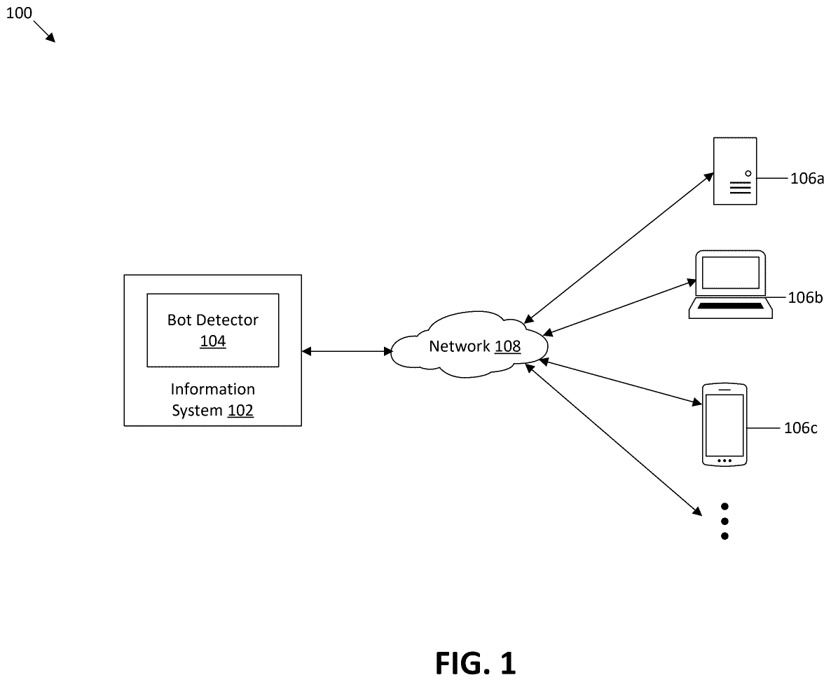

FIG. 1 illustrates an example network environment 100 in which aspects of the present disclosure may be implemented. The network environment 100 includes an information system 102, a bot detector 104, and a plurality of devices 106.

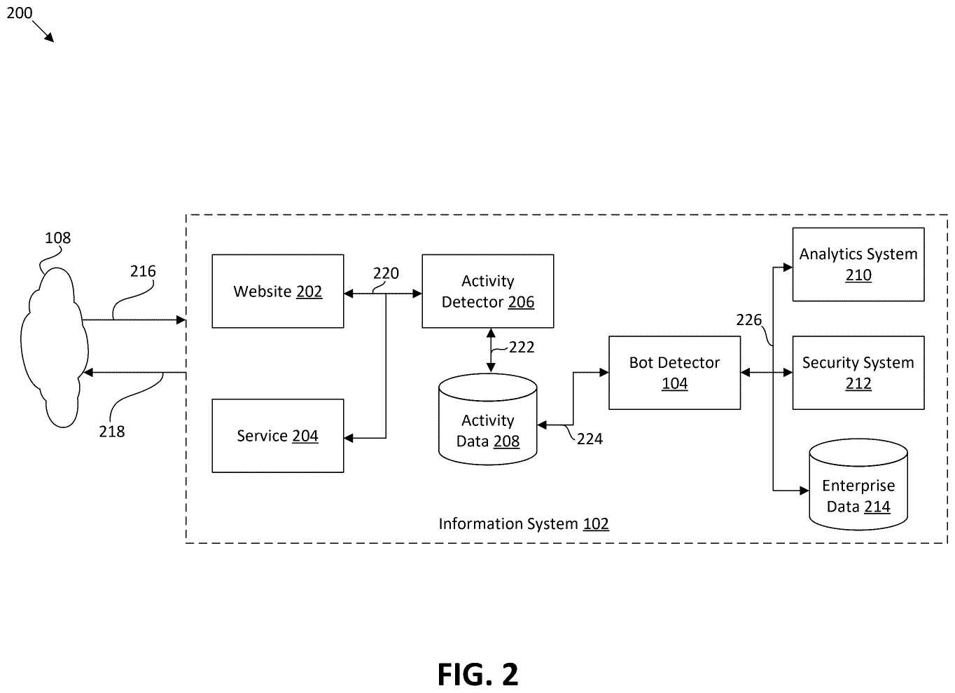

The information system 102 may be a collection of software, hardware, networks, data, and people. The information system 102 may be associated with an organization. For example, the organization may use, develop, maintain, own, or otherwise be associated with components of the information system 102. In some embodiments, the information system 102 is associated with a retailer. The information system 102 may include one or more frontend systems via which the devices 106 may interact with the information system 102. The frontend systems may include web pages of a website or a mobile application that can be accessed by one or more of the devices 106. Some components of the information system 102 may operate in a common computing environment. Some components of the information system 102 may operate in different computing environments and communicate over a network, such as the internet or a local network. Some components of the information system 102 may be developed and maintained by a third-party (e.g., an entity different than the organization with which the information system 102 is associated). As shown, the information system 102 may include the bot detector 104. Example components of the information system 102 are illustrated and described in connection with FIG. 2.

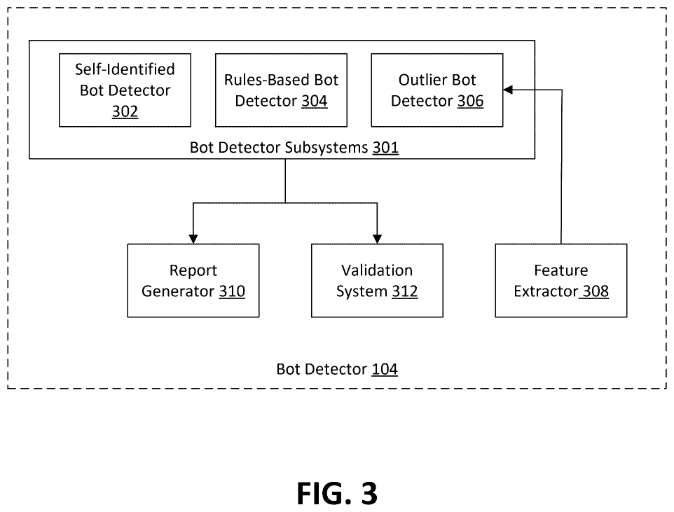

The bot detector 104 may include software and hardware for detecting bots. A bot may be a software application that is programmed to perform one or more tasks. In some embodiments, the bot detector 104 detects bots that are running on one or more of the devices 106 and that communicate with components of the information system 102. In some embodiments, the bot detector 104 may include a plurality of subsystems for detecting bots. For example, the bot detector 104 may include a system for identifying self-identified bots, a system for applying one or more rules to identify bots, and a system for identifying bots based on outlier behavior, or activity, of the bots. The bot detector 104 may further include systems for extracting features in activity data, validating bot classifications, and providing results to downstream systems. Example aspects of the bot detector 104 are described further in connection with FIG. 3.

In some embodiments, there may be various types of bots. For example, bots may include one or more of web crawlers, aggregators, price scrapers, resellers, hacker bots (e.g., bots that perform account take over, credential stuffing, distributed denial of service attacks, or other malicious activity), advertising abuse bots, fraud bots, or other types of bots. In some embodiments, bots may be part of a coordinated attempt to hack components of the information system 102. In some embodiments, bots may be part of a bot net, which may include a network of devices or bots that are organized to carry out a task. In some embodiments, bots may be associated with an entity, such as a search engine or analytics platform. In some embodiments, the bot detector 104 may be configured to identify many types of bots, whereas in other embodiments, the bot detector 104 may be configured to identify a particular type of bot or subset of bot types.

The devices 106 may be devices that can communicate with components of the information system 102. In the example of FIG. 1, the devices 106 include a computing system 106a, a laptop 106b, and a mobile phone 106c. The devices 106 may include more devices and types of devices than those depicted in FIG. 1, such as Internet of Things (IoT) devices, a cluster of devices, a virtual device, or another type of device. Each of the devices 106 may be associated with one or more users, which may be an entity that uses a component of one of the devices 106 to communicate with the information system 102. A user may be a human or a bot. When a user communicates with a component of the information system 102, the may be a visitor of that component (e.g., a visitor of a website).

In some embodiments, one or more of the devices 106a-c may execute applications that are bots. These bots may be programmed to send requests to components of the information system 102 and may process data received from the information system 102. In some embodiments, one or more of the devices 106 may be used by a human user to access components of the information system 102. The human user may be, for example, a customer of a retailer associated with the information system 102 or a business partner of the retailer associated with the information system 102. In some embodiments, one or more of the devices 106 may use a web browser, mobile application, or other software program for communicating with the information system 102.

The network environment 100 may include more or fewer components than depicted in the example of FIG. 1. For example, the environment 100 may include an external system associated with a third party that is communicatively coupled with the information system 102. For example, the external system may provide software, platform, or infrastructure as a service that is used by the information system 102. In some embodiments, an external system may provide a service for the bot detector 104. For example, in some embodiments, the bot detector 104 may use an external system to receive keywords for identifying bots, to develop a machine learning model for detecting bots, or for other tasks.

The network 108 may communicatively couple components of the information system 102 with the devices 106. In some embodiments, some components that are part of the information system 102 are communicatively coupled with one another via the network 108. The network 108 may be, for example, a wireless network, a wired network, a virtual network, the internet, or another type of network. Furthermore, the network 108 may include subnetworks, and the subnetworks may be different types of networks or the same type of network.

FIG. 2 illustrates a schematic block diagram 200 of example components of the information system 102. Furthermore, the block diagram 200 depicts example data exchanges between components of the information system 102. In the example of FIG. 2, the information system 102 includes a website 202, a service 204, an activity detector 206, activity data 208, the bot detector 104, an analytics system 210, a security system 212, and enterprise data 214. The information system 102 may include more or fewer components than those illustrated in FIG. 2. For example, the information system 102 may further include a data storage system, developer tools or a developer platform, code repositories and code management systems, logging systems, various types of hardware for performing computations, interfaces for communicating within the information system 102 and with components external to the information system 102, administrative systems, systems for assisting retail operations, such as an item catalog, demand forecasting tools, pricing tools, digital advertising systems, or other systems that may be part of a digital infrastructure. In some embodiments, one or more of the additional components of the information system 102 may be communicatively coupled, either directly or indirectly, with the bot detector 104.

The website 202 may be one or more websites, each of which may include one or more web pages. The website 202 may be served from one or more web servers to devices that access the web servers. The devices may include, for example, the devices 106 of FIG. 1. The website 202 may be accessed by both bot users and human users. The website 202 may provide various displays, services, and functions to users. In some embodiments, the website is associated with a retailer.

Depending on the embodiment, the website 202 may include different components, which may include various web pages and functions offered by the website 202. The activity at the web pages and the use of the functions may be analyzed by the bot detector 104 to detect bots. In some embodiments, the website 202 may enable users to perform actions related to items. For example, the website 202 may include a home page of a retailer, and the home page may provide various tools for interacting with items. For example, the website 202 may include an item search system. Via the item search system, a user may input one or more alphanumeric characters to search for a product offered by the website 202. As another example, the website 202 may include a web page and a collection of functions for adding items to a digital shopping cart, for purchasing items, and for facilitating a shipment of the items. When an item is purchased, the website 202 may register this purchase as demand.

As another example, the website 202 may enable a user to sign into an account associated with a retailer or an account that is otherwise associated with the information system 102. Based on this account, the user may be associated with a user-specific identifier for a retailer. As another example, the website 202 may include item pages that display additional information for one or more items. In some embodiments, the item pages may be organized hierarchically. For example, a first-level item page may include a category of items, a second-level item page may include a sub-category of items, and a third-level item page may include a particular item or a further refined sub-category of items. In some embodiments, the website 202 may include selectable advertisements. In some embodiments, a user (whether bot or human) may navigate to a page of the website 202 via a link from a different website or application. The website 202 may be coupled with various components that facilitate operations of the website 202, such as a scalable infrastructure, load balancing, caching systems, data storage systems, diagnostics tools, deployment systems, and other systems. In some embodiments, one or more of such components may form part of the service 204.

The service 204 may include one or more software or hardware services that are provided to other components. For example, the services 204 may provide services to one or more of the website 202, a mobile application, another component of the information system 102, or a third-party system. Although depicted as a single component, the service 204 may include a plurality of distinct services. For example, the website 202 may call the service 204 to perform a function offered by the website 202. For example, the website 202 may call the service 204 to provide, manage, update, or retrieve data or to perform other operations. In some embodiments, the service 204 includes application programming interfaces (APIs) that are called by other components. In some embodiments, the service 204 is a software library. In some embodiments, services of the service 204 are implemented as microservices. In some embodiments, the service 204 may be called by the devices 106. For example, the service 204 may be called by a mobile application associated with the information system 102 that is installed on one or more of the devices 106. In some embodiments, the activity detector 206 can monitor activity of the service 204, and such activity data may be monitored to distinguish between bot-related activity and human-related activity.

The activity detector 206 may detect activity associated with other components. For example, the activity detector 206 may monitor the website 202, the service 204, or other components and may record data corresponding to such activity. This data may be stored as part of the activity data 208. Depending on the embodiment, the implementation of the activity detector 206 may vary and the manner in which the activity detector 206 collects data may vary.

In some embodiments, the activity detector 206 may include code that is integrated into a monitored application. A monitored application may be a program that generates, receives, selects, or is otherwise associated with data that is monitored by the activity detector 206. A monitored application may include applications of the website 202 or the service 204. When a monitored application is executed, such code that is associated with the activity detector 206 may also be executed, thereby providing data to the activity detector 206. In some embodiments, the activity detector 206 may include one or more APIs that are called by monitored programs to provide activity data to the activity detector 206. In some embodiments, the activity detector 206 may include components that generate log data or that receive log data, where the log data corresponds to activity at a monitored application. In some embodiments, the activity detector 206 may include software or hardware for monitoring network traffic that is sent or received by a monitored application. In some embodiments, the activity detector 206 uses a combination of components for collecting activity data.

The activity detector 206 may apply various techniques to organize activity data. For example, the activity detector 206 may in part organize activity by user. For instance, the activity detector 206 may determine activity for a user of the website 202. The activity detector 206 may assign the user an identifier. To do so, the activity detector 206 may, in some embodiments, use cookies that include the identifier for the user. Using the identifier, the activity detector 206 may monitor activity of the user across time. In some embodiments, the activity detector 206 may derive data based on the activity data collected from a monitored application. For example, by monitoring a user across multiple actions, the activity detector 206 may derive metrics associated with a plurality actions, such as a number of IP addresses associated with a user, a total demand associated with a user, a number of particular actions taken by a user, or other such multi-action metrics.

The activity data 208 may include data that is collected, generated, or otherwise processed by the activity detector 206 or other another component. The activity data 208 may be stored in a data storage system accessible to the bot detector 104. The data storage system may be, for example, cloud storage system or a hybrid storage system.

In some embodiments, the activity data 208 includes data for a plurality of users, where each of the users is associated with data corresponding to one or more features. In some embodiments, the activity data 208 may be organized by one or more of a user identifier, another identifier, time, date, source location, destination location, IP address, user agent string, feature, feature value, or other data field. In some embodiments, an entry in the activity data includes a user and feature values of the user for a plurality of features. The features may be, for example, columns that represent data fields in the activity data, and the feature values for a user may be values for that user across the features. For example, if a feature is “number of pages viewed,” then a corresponding feature value for a user may be the number of pages that user viewed, such as 1, 4, 5, or another number. In some embodiments, an action, and data derived from an action, at a monitored application, whether initiated by a user, by the monitored application, or another program, may correspond to a data entry in the activity data 208. In some embodiments, a plurality of actions, and data derived from the actions, that correspond to a particular user may correspond to a data entry in the activity data 208.

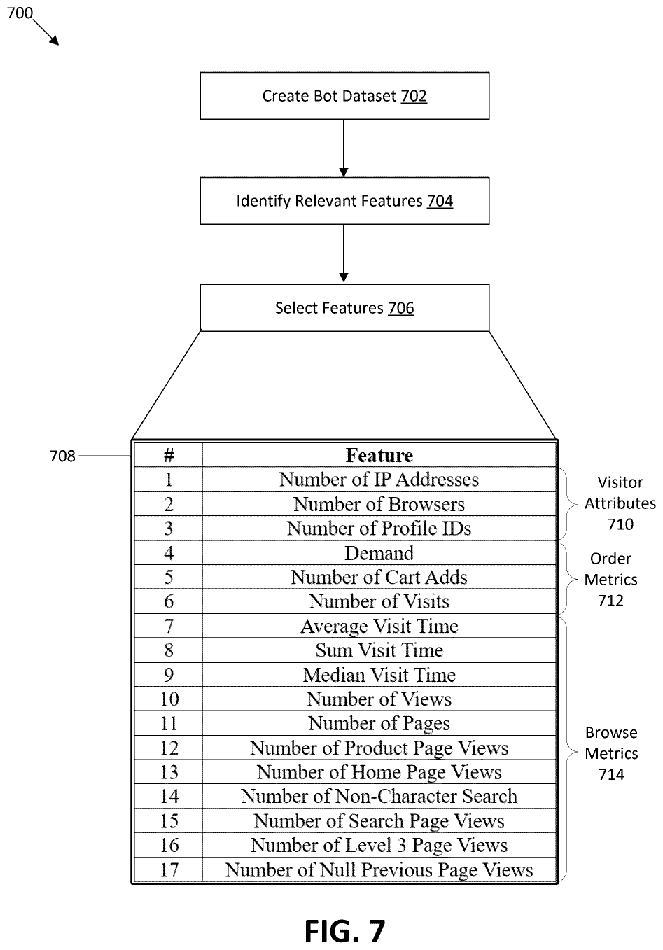

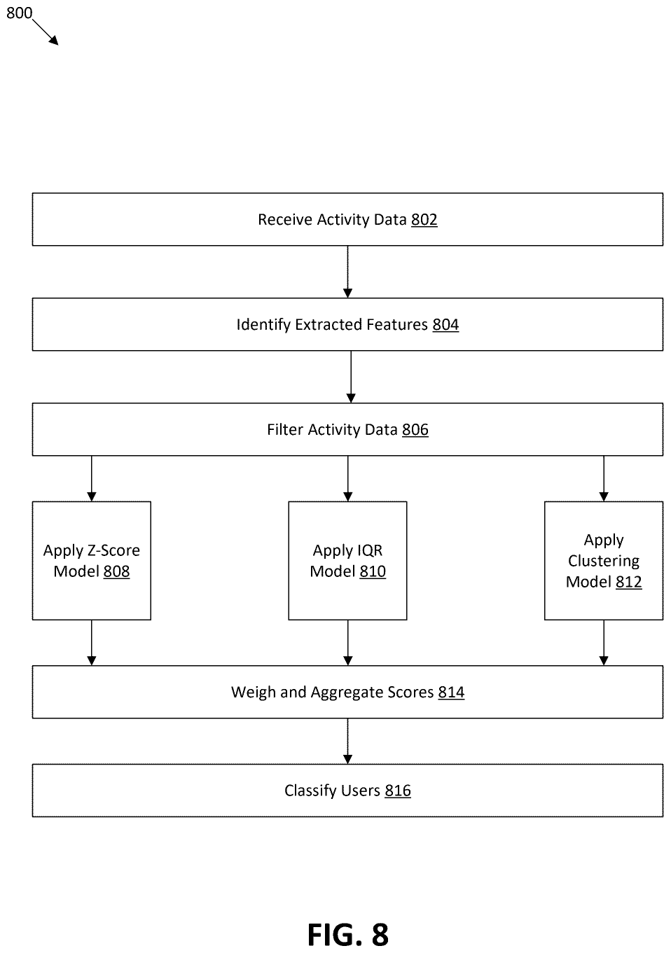

Examples of features in the activity data 208 may include, but are not limited to, the following: date; time; user ID; number of IP addresses associated with a user in a day or another span of time; number of browsers (or user agents) associated with a user in a span of time; number of platform-specific IDs associated with a user; demand; number of sessions associated with a user; number of times a particular action was performed, such a number of adds to a cart, number of total page views, number of item page views, number of non-character searches, number of home page views, number of times a function or service was called, number of views of a type of page, number of search page views, or number of other actions; inputs provided as part of performing a particular action; amount of time for a session; total amount of time for a user using a monitored application; clicks; click locations; activity speed; number of page views in which a previous page is null; or other activity associated actions performed by a monitored application, by communication including a monitored application, or derived from actions or communications associated with a monitored application. In some embodiments, a subset of the features in the activity data may be used to detect bots based on outlier activity, as described in connection with FIGS. 7-8.

The analytics system 210 may include software and hardware for receiving, processing, and displaying data from one or more of the bot detector 104 or another component of the information system 102, such as the enterprise data 214. In some embodiments, the analytics system 210 may include interactive dashboards for navigating, displaying, and sharing data from the bot detector 104. For example, the analytics system 210 may indicate, for a given time period, which users to the website 202 were bots and which users were humans. Based on such information, the accuracy or effectiveness of the analytics system 210 or another system, may be improved. For example, when evaluating activity on the website 202, bot users may be filtered out, thereby focusing the analysis on human users, which may provide more meaningful insight into patterns or trends of the website 202 that are caused by human activity, rather than bot activity. Such analysis may relate, for example, to pageviews, click-through rates, bounce rates, time spent on the website 202, conversion rates (e.g., percentage of human users who generate demand), or other analysis that may be relevant to an entity associated with the information system 102. Conversely, in some instances the analytics system 210 may filter out human activity, thereby improving processes that related to analyzing bot data, which may include operations of the security system 212.

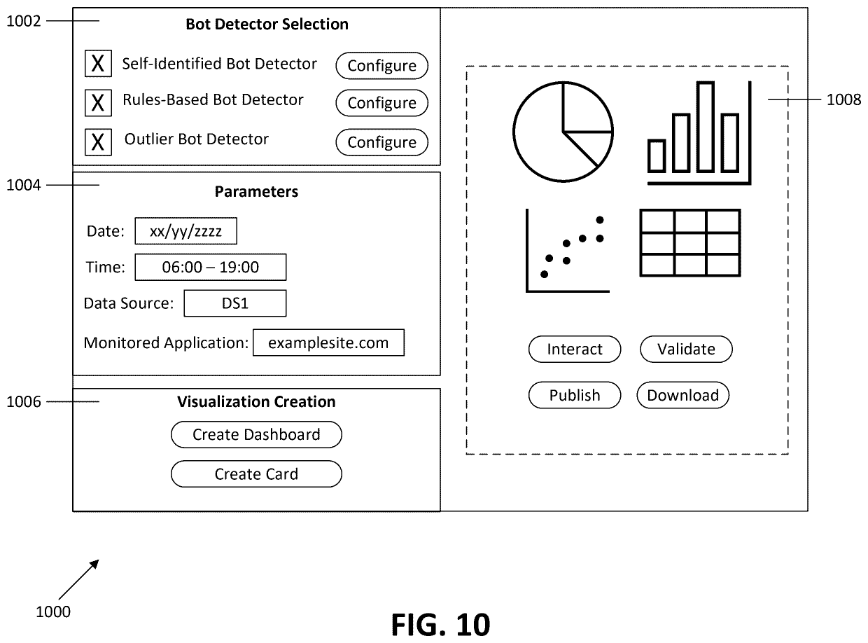

In some embodiments, the analytics system 210 may include one or more graphical user interfaces (GUI) that include input fields for searching and organizing data from the bot detector 104, and the one or more GUIs may include visualizations for depicting select data from the bot detector 104. Example aspects of such a GUI are illustrated and described in connection with FIG. 10. In some embodiments, the analytics system 210 may be configured to selectively activate subcomponents of the bot detector 104. For example, via the analytics system 210, or via another application, an administrator may select which of a plurality of bot detection subcomponents of the bot detector 104 are used to detect bots. Furthermore, the administrator may be able to select a threshold confidence level for identifying a user as a bot, and the administrator may be able to define a type of bot to be identified or a type of behavior that is to be identified as corresponding to a bot. In some embodiments, an administrator may be an engineer, data analyst, or other person associated with the information system 102

The security system 212 may include software and hardware for protecting components of the information system 102 from bots. For example, in response to determining that a user is a bot, the security system 212 may take one or more actions with respect to that bot. Such action may include, for example, denying requests received from the bot, blocking access of the bot to components of the information system 102, or capturing data associated with the bot (e.g., an IP address associated with the bot, a user agent string associated with the bot, or an activity or activity pattern associated with the bot) for use in subsequent security operations. For example, the security system 212 may block future traffic associated with an IP address or user agent string of an identified bot. In some embodiments, the security system 212 may operate in real time to perform security operations associated with the bots.

The enterprise data 214 may include data of an entity associated with the information system 102. In some embodiments, the bot detector 104 may store data related to bot detection in the enterprise data 214. In some embodiments, one or more of the bot detector 104, the analytics system 210, and the security system 212 may use data from the enterprise data 214 as part of performing their respective operations. Examples of data included in the enterprise data 214 include the following: data associated with other components of the information system 102; item data; customer data; pricing data; advertising data; testing data; location data, where a location may include one or more of a retail store, a warehouse, a sortation center, or a partner location; vendor or other partner data; item forecast data; and other data.

FIG. 2 further illustrates example operation 216-226 that may represent data exchanges involving components of the information system 102.

At operation 216, a component of the information system 102 may receive a request. For example, the website 202 may receive a request. The request may be, for example, a request for a web page of the website 202. As another example, the request may relate to performing a function provided by the website 202, such as using a search tool, clicking on an advertisement, adding an item to a cart, purchasing an item, playing a media item, or performing another action. The request may be sent by one or more of the devices 106, and it may be associated with a user, which may be a bot or a human. In some embodiments, the request includes cookies that identifies the user that provided the request.

At operation 218, a component of the information system 102 may output a response. The response may be associated with the request received at the operation 216. In some embodiments, the response may be a web page requested by a user, the response may be instructions to be executed by the device, the response may include data to be processed by the device, the response may be media content, or the response may include other information. In some embodiments, the response may include a confirmation that an action was performed by the website 202, the service 204, or another component of the information system 102. In some embodiments, the response includes cookies for subsequently identifying a user that sent the request.

At operation 220, the activity detector 206 collects data associated with one or more of the website 202 or the service 204. As described above, depending on the embodiment, the activity detector 206 may be implemented in various ways; therefore, the manner in which activity data is collected may vary. In some embodiments, the activity detector 206 may collect data in real time as the website 202 or the service 204 receives, processes, and responds to request. In some embodiments, the activity detector 206 simultaneously collects data associated with different users, such as different users accessing the website 202. In some embodiments, the activity detector 206 may derive additional data based on the data collected from monitored applications.

At operation 222, the activity detector 206 may store data as part of the activity data 208. For example, the activity detector 206 may input data into a data storage system that stores the activity data 208. In some embodiments, the activity detector 206 may convert the activity data into a standardized format to be stored as the activity data 208. For example, the activity detector 206 may, for a user, identify values for the user associated with features that are part of the activity data, and the activity detector 206 may associate those values with the user. In some embodiments, the activity detector 206, stores activity data 208 in batches.

At operation 224, the bot detector 104 may retrieve activity data 208. In some embodiments, the bot detector 104 may retrieve the activity data as part of a process for detecting bots. In some embodiments, this process may be executed daily. In some embodiments, the bot detector 104 receives activity data 208 that is associated with a previous day. In some embodiments, the bot detector 104 may be executed more frequently. For example, in some embodiment, the bot detector 104 may retrieve activity data 208 in real time in response to updates toe the activity data 208. In some embodiments, the bot detector 104 may retrieve data from the activity 208 that has certain characteristics, such as activity data associated with a particular web page or action of the website 202 or associated with a subset of users. Having retrieved at least some of the activity data 208, the bot detector 104 may analyze the retrieved activity data to detect bots.

At operation 226, the bot detector 104 may provide data to one or more downstream systems, such as the analytics system 210, the security system 212, or the enterprise data 214. In some embodiments, a publisher-subscriber architecture or messaging queue are used to facilitate communication between the bot detector 104 and the downstream systems. In some embodiments, the bot detector 104 provides the activity data 208 along with a classification of whether users in the activity are bots or not bots. Furthermore, the bot detector 104 may provide data related to the determination that a user was a bot, such as a confidence score, an identity of a component used to determine that a user was a bot, or other data. In some embodiments, the bot detector 104 may only provide aspects of the activity data 208, and aspects of the data derived by the bot detector 104, that is relevant to a particular downstream system. For example, whereas a confidence level for a bot classification may be provided to the analytics system 210, the confidence level may not be provided to a different downstream system, such as the enterprise data 214.

FIG. 3 illustrates a schematic block diagram of the bot detector 104. The bot detector 104 may include various data, software, and hardware for detecting bots. As described herein, the bot detector 104 may include bot detector subsystems 301 for detecting bots and each of the subsystems may implement a different technique for bot detection. Furthermore, the bot detector 104 may include additional components, such as components for pre-or post-processing data or components for assisting bot detection systems. In the example of FIG. 3, the bot detector 104 includes a self-identified bot detector 302, a rules-based bot detector 304, an outlier bot detector 306, a feature extractor 308, a report generator 310, and a validation system 312. The bot detector 104 may include more or fewer components than those depicted in the example of FIG. 3.

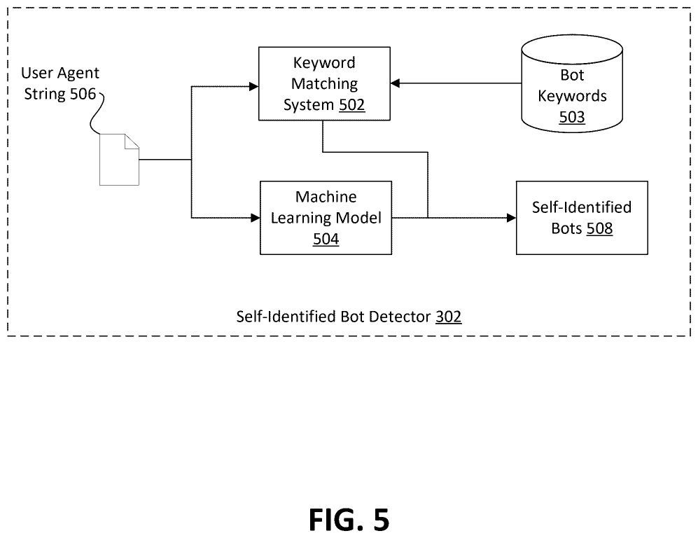

The self-identified bot detector 302 may be a system that detects bots that self-identity as bots. In some embodiments, a self-identified bot is a bot that provides data indicating that it is a bot. In some embodiments, a self-identified bot may include data in its user agent string that identifies it as a bot. For example, a self-identified bot may include a keyword in its user agent string that identifies it as a bot. Examples of such keywords may include “bot,” “headless,” or “spider.” In some embodiments, the self-identified bot detector 302 may be communicatively coupled with a system that stores a list of keywords used by known self-identified bots to identify themselves as bots, such as for example, a list provided by the Internet Advertising Bureau (IAB) of known bots. In some embodiments, the self-identified bot detector 302 may also include one or more machine learning models to detect bots by using natural language processing techniques. Example aspects of the self-identified bot detector are further illustrated in connection with FIG. 5.

The rules-based bot detector 304 may be a system that identifies bots by applying one or more rules. A rule may be for example, one or more conditions and associated actions. There may a plurality of possible rules. In some embodiments, some of the rules may be activated while others are not. In some embodiments, rules may be defined by a human user, such as an administrator of the bot detector 104, so that the rules may be customized to a particular use case. In some embodiments, one or more rules may be defined by an artificial intelligence system.

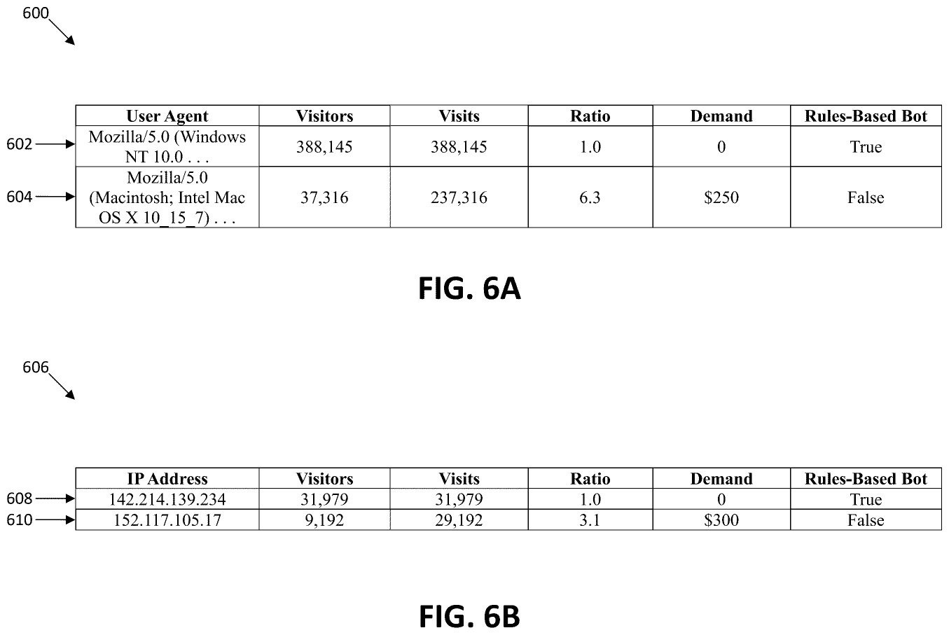

An example rule may be that, if an IP address is associated with a sufficiently similar number of users (e.g., visitors) as visits (e.g., the deviation between the number of users associated with an IP address and the number of visits associated with the IP address is within a five percent difference), and if no demand is generated from these visits (or if a sufficiently low amount of demand is generated from these visits), then all users associated with that IP address may be classified as a bot. Such a rule may, for example, identify an IP address that is only associated with bots. Another example may be that if an user agent string is associated with a sufficiently similar number of users as visits (e.g., the deviation between the number of users associated with a user agent string and the number of visits associated with the user agent string is within a five percent difference), and if no demand is generated from these visits (or if a sufficiently low amount of demand is generated from these visits), then all users associated with that user agent string may be classified as a bot Other rules are likewise possible. In some embodiments, rules may be customized based on the application that is being monitored (e.g., a rule for a website of a retailer may be different than a rule for a digital media system, which may be different from a rule associated with an entity that provides a different service or product). In some embodiments, the rules-based bot detector 304 may be associated with an interface via which an administrator may define rules used by the rules-based bot detector 304 to detect bots. Example rules are further described in connection with FIGS. 6A-6B.

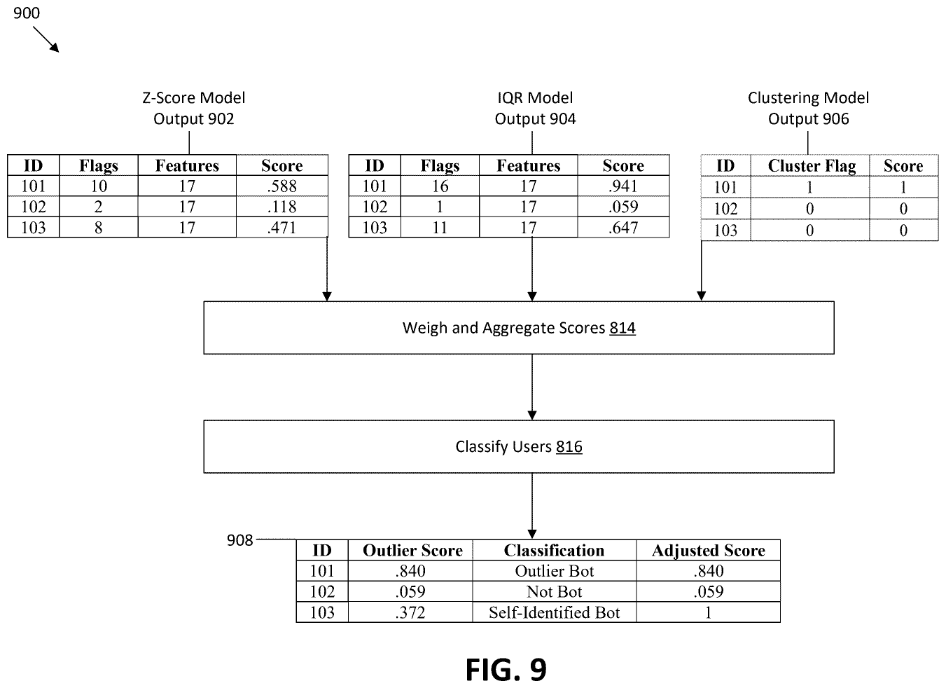

The outlier bot detector 306 may be a system that identifies bots based on their behavior, or activity. For example, the outlier bot detector 306 may identify a user as a bot if its activity is sufficiently different from activity of other users, as based, for example, on deviations from a mean, standard deviation, or other metric. In some embodiments, the outlier bot detector 306 may analyze values for one or more features received from the feature extractor 308 to determine whether a user is a bot. In some embodiments, the outlier bot detector 306 includes a plurality of models to determine whether a user is a bot. For example, the outlier bot detector 306 may use output from each of the plurality of models to determine whether a user is a bot. In some embodiments, the outlier bot detector 306 may include a statistical model (e.g., a Z-Score model and/or an IQR model) and a clustering model (e.g., a K-Means clustering model). Example aspects of the outlier bot detector 306 are further described in connection with the FIGS. 8-9.

In an example embodiment, once the bot detector 104 has received activity data, the bot detector 104 may apply one or more of the bot detectors 302-306. In some embodiments, the bot detector 104 may apply the bot detectors 302-306 sequentially, the bot detector applies the self-identified bot detector 302 then the rules-based bot detector 304 and then the outlier bot detector 306. However, depending on the embodiment, the order in which the bot detectors are applied may vary. In some embodiments, the bot detectors 302-306 may be applied simultaneously.

The bot detector 104 may provide the output of the bot detectors 302-306 to one or more of the report generator 310 or the validation system 312. In some embodiments, the bot detector 104 may first aggregate respective outputs of the bot detectors 302-306 prior to providing the aggregated output to the one or more of the report generator 310 or the validation system 312. In some embodiments, the bot detector 104 may provide the output from one or more of the bot detector subsystems without first aggregating the respective outputs.

The feature extractor 308 may determine features that are used by the outlier bot detector 306 for identifying bots. A feature may be data, a characteristic, or an activity of a user that interacts with the information system 102, such as a user that interacts with the website 202. In some embodiments, the feature extractor 308 may determine a subset of features of the features in the activity data, and this subset of features may be used by the outlier bot detector 306 to identify outliers.

In some embodiments, the feature extractor 308 may select features that enable the outlier bot detector 306 to distinguish bot users from human users. Therefore, in some instances, at least some of the features identified by the feature extractor 308 may be features that emphasize differences between human users and bot users. In some embodiments, the feature extractor 308 may select different types of features, such as features related to user attributes, features related to particular actions taken by a user at the website 202, or features that related to activity of the user. In some embodiments, the feature extractor 308 may use a labeled set of data that identifies users as human users or bot users, and the feature extractor 308 may apply a cross-correlation analysis to identify, form a plurality of potential features, a subset of features that may be used to identify bots. Example aspects of the feature extractor 308 are further described in connection with FIG. 7.

The report generator 310 may be a system that receives data from on or more of the bot detectors 302-306 and, based at least in part on this data, generates or displays data related to bot detection. In some embodiments, the report generator 310 is part of the analytics system 210.

The validation system 312 may be a system that validates output of one or more of the bot detectors 302-306. For example, the validation system 312 may verify the accuracy of bot classifications from one or more of the bot detectors 302-306. In some embodiments, the validation system 312 may receive data from another system that serves s ground truth for comparing with the data of the bot detectors 302-306. For example, the validation system 312 may receive bot classification data from the security system 212 that may be used to validate bot classifications from the bot detectors 302-306. In some embodiments, the validation system 312 may output data that can be used to evaluate the performance of one or more of the bot detectors 302-306. In some embodiments, in response to the validation system 312 determining that a performance (e.g., an accuracy, precision, recall, or F-Score) is below a threshold value, a configuration of one or more of the bot detector subsystems 301 may be altered. In some embodiments, the validation system 313 may output results to the report generator 310 or to the analytics system 210.

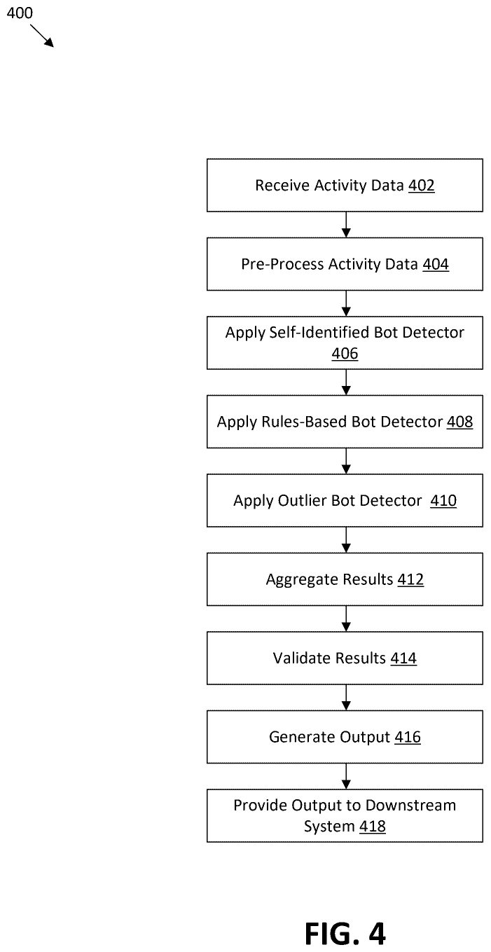

FIG. 4 is a flowchart of an example method 400 for identifying bots. As described herein, the method 400 is described as being performed by the bot detector 104. However, one or more operations of the method 400 may be performed by a different component of the information system 102. Furthermore, different subcomponents of the bot detector 104 may perform different operations of the method 400.

In the example shown, the bot detector 104 may receive activity data (operation 402). For example, the bot detector 104 may receive data from the activity detector 206 or the activity data 208 described in connection with FIG. 2. In some embodiments, the bot detector 104 may receive activity data from a previous day. For example, the bot detector 104 may identify bots associated with activity of a previous day at the website 202. In some embodiments, the bot detector 104 may receive activity data corresponding to a time range within a day or corresponding to multiple days, such as for a previous week or for a time that was associated with a holiday or promotion. In some embodiments, the bot detector 104 may receive activity data in real time. For example, as a user is interacting with the website 202, activity data may be collected for that user and analyzed by the bot detector 104. In some embodiments, the bot detector 104 may receive data for a subset of web pages of the website 202, for a subset of activity data corresponding to a particular action or service, or for a subset of users.

In the example shown, the bot detector 104 may pre-process the activity data (operation 404). For example, the bot detector 104 may filter, organize, convert, supplement, or prune the activity data such that a bot detector subsystem may identify bots in the data or so that a bot detector subsystem may more effectively identify bots in the data. In some embodiments, this may include separating the activity into different groups of data. For example, in some embodiments, the bot detector 104 may separate users associated with demand (e.g., a purchase at a retailer website) from users that are not associated with any demand. In such embodiments, the bot detector 104 may apply one or more of the bot detector systems 302-306 separately for the different groups of data. As another example of pre-processing data, the bot detector may identify single-page visitors, which may be users that only visit a single page of the website 202 in a day or in another time period.

In some embodiments, the bot detector 104 may combine different data entries that correspond to a common user so that the activity data may be analyzed on both a per-user and per-session granularity. In some embodiments, the bot detector 104 may extract the data that is to be used by the one or more of the bot detectors 302-306. For example, the bot detector 104 may extract, for a user, a user agent string, an IP address, and values for the one or more features that may be used by the outlier bot detector 306.

In the example shown, the bot detector 104 may apply the self-identified bot detector 302 to identify a set of bots (operation 404). A set of bots may include zero or more bots. The self-identified bot detector 302 may determine that a user is a bot based the user agent string associated with the user. For example, the self-identified bot detector 302 apply one or more of sting matching or a machine learning model to determine self-identified bots. After applying the self-identified bot detector 302, one or more of the users in the activity data may be classified as a self-identified bot. Example aspects of the self-identified bot detector 302 are described further in connection with FIG. 5.

In the example shown, the bot detector 104 may apply the rules-based bot detector 304 to identify a set of bots (operation 408). In some embodiments, the bot detector 104 may identify one or more active rules and apply the one or more active rules. In some embodiments, the bot detector 104 may use the rule-based bot detector 304 to identify one or more of more IP addresses or user agent strings that are to be associated with bots. In some embodiments, the bot detector 104 may also use previously identified IP addresses or user agent strings to classify users as bots. In some embodiments, the rules are defined such that users associated with an identified bot net or bot farm are identified as bots. Example aspects of applying the rules-based bot detector are described in connection with FIG. 6

In the example shown, the bot detector 104 may apply the outlier bot detector 306 to identify a set of bots (operation 410). For example, bot detector 104 may determine one or more users in the activity data that are outliers based on one or more features. This may include applying one or more outlier detection models. For example, identifying whether a user is an outlier may include determining whether a value of a feature for the user is greater than a range from a center value, such as X number of standard deviations from a mean or X number of interquartile ranges from a median. Identifying whether a user is an outlier may further include using a clustering model that clusters users base don feature values and then determining a distance of the user to a center of a cluster to which the user is assigned. Example aspects of the outlier bot detector 306 are further described in connection with FIGS. 8-9.

In the example shown, the bot detector 104 may aggregate results (operation 412). For example, in some instances, the bot detector 104 may combine results from one or more of the self-identified bot detector 302, the rules-based bot detector 304, or the outlier bot detector 306. Additionally, in some embodiments, the bot detector 104 may aggregate results from multiple iterations of one or more of the bot detectors 302-306. For example, the bot detector 104 may apply the outlier bot detector 306 a first time for a first subset of the activity data and a second time for a second subset of activity data. For example, the first subset of activity data may include activity of users who did not generate demand and activity of users who did generate demand. As another example, the first subset of activity data may include users that visited a single page, and the second subset of activity data may include users that visited multiple pages. The self-identified bot detector 302 and the rules-based bot detector 304 may also be applied multiple times for different subsets of the activity data. In the example shown, the bot detector 104 may aggregate the results from across the bot detectors 302-306 and from across different applications of the bot detectors 302-306.

In the example shown, the bot detector 104 may validate results (operation 414). For example, the bot detector 104 may use the validation system 312 described in connection with FIG. 3 to validate the results from one or more of the self-identified bot detector 302, the rules-based bot detector 304, or the outlier bot detector 306. By validating the results, the bot detector 104 may assess a performance of the bot detector subsystems 301 as a group or may assess an accuracy of the bot detector subsystems individually. In some embodiments, the bot detector 104 may alter a configuration of one or more of the bot detector subsystems 301 based on the results of the validation.

In the example shown, the bot detector 104 may generate an output (operation 416). The output may include a classification of whether each user of the plurality of users in the activity data analyzed by the bot detector 104 is a bot. In some embodiments, the bot detector 104 may output aspects of the activity data (e.g., features values for a plurality of users) and may add data to the activity data. For example, the bot detector 104 may, for each user, output a binary flag indicating whether the user is a bot. In some embodiments, the bot detector 104 may output an indication of which of the bot detector subsystems 302-306 flagged the user as a bot. For example, the bot detector 104 may output, for a user, whether the user was classified as a bot by the self-identified bot detector 302, the rules-based bot detector 304, the outlier bot detector 306, or multiple of the bot detector subsystems 302-306. Additionally for a user, the bot detector 104 may output further data related to the bot detection process.

In some embodiments, this additional information may depend on which of the bot detectors 302-306 was used to classify the user as a bot. For example, if the user was identified by the self-identified bot detector 302 as a bot, then the bot detector 104 may output a keyword or other text that was recognized by the self-identified bot detector 302 to classify the user as a bot. As another example, if the user was identified as a bot by the rule-based bot detector 304, then the bot detector 104 may output an IP address or user agent string of the user that may have been identified by the user as associated with bot source. As another example, the bot detector 104 may output a score determined by the outlier bot detector 306, and the score may correspond with an estimated likelihood that the user is a bot. Furthermore, for the embodiment in which the outlier bot detector 306 includes a plurality of models, the bot detector 104 may output a score from each of the models. As another example, the bot detector 104 may output one or more features for which the user may have been determined to be an outlier.

In the example shown, the bot detector 104 may provide the output to the downstream system (operation 418). For example, the bot detector 104 may provide the output to one or more of the analytics system 210, the security system 212, the enterprise data 214, or another component.

FIG. 5 illustrates a schematic block diagram of an example architecture of the self-identified bot detector 302 of FIG. 3. In the example of FIG. 5, the self-identified bot detector 302 includes a keyword matching system 502, bot keywords 503, and a machine learning model 504. Additionally, the example of FIG. 5 illustrates that the self-identified bot detector 302 may apply one or more of the keyword matching system 502 or the machine learning model 504 on a user agent string 506, or a plurality of user agent strings, to determine self-identified bots 508.

The keyword matching system 502 may be a system that analyzes text to identify the presence or absence of keywords. In some embodiments, the keyword matching system 502 applies one or more algorithms for efficiently searching a text string for the presence of one or more keywords. In the example shown, the keyword matching system 502 may search the user agent string 506 for keywords of the bot keywords 503. If one or more of the bot keywords 503 is present in the user agent string 506, then the self-identified bot detector 302 may determine that the user associated with the user agent string is a bot.

The bot keywords 503 may include a plurality of words, alphanumeric strings, or phrases that may be used by the keyword matching system 502 to identify bots. In some embodiments, the bot keywords is provided by an organization that provides a list of keywords associated with known bots. Such an organization may be for example, the international advertising bureau (IAB) or another organization. In some embodiments, the list of keywords may be modified by an administrator of the information system 102. In some embodiments, the bot keywords 503 may be a combination of different lists that include keywords associated with known bots.

The machine learning model 504 may be a machine learning model configured to receive text (e.g., a user agent string) and to classify whether the text is associated with a bot. In some embodiments, the machine learning model 504 is trained to perform natural language processing tasks. In some embodiments, the machine learning model 504 uses a pre-trained neural network that has been fine-tuned to recognize a bot based on text associated with the bot. In some embodiments, the machine learning model is a transformer-based model that uses embeddings of user agent strings (and/or other text) to predict whether a user is a bot. In some embodiments, the machine learning model 504 may be trained at least in part using the bot keywords 503, but the machine learning model 504 may be able to recognize at least some bots that may not use any keywords of the bot keywords 503.

In some embodiments, if the machine learning model 504 determines that the user agent string 506 is associated with a bot, then the self-identified bot detector 302 determines that it is associated with a self-identified bot. As a result, if either keyword matching system 502 or the machine learning model 504 determines that the user agent string is a bot, then the self-identified bot detector 302 determines that it is a bot. In some embodiments, the self-identified bot detector 302 may use the keyword matching system 502 but not the machine learning model 504. In some embodiments, the self-identified bot detector 302 may use the machine learning model 504 but not the keyword matching system 502. In some embodiments, the self-identified bot detector 302 may use additional techniques for detecting self-identified bots.

The user agent string 506 may be associated with one or more users in the activity data that is analyzed by the bot detector 104. Although depicted as a single user agent string in the example of FIG. 5, the user agent string 506 may be a plurality of user agent strings that may be analyzed by one or more of the keyword matching system 502 or the machine learning model 504.

FIGS. 6A-6B illustrate example applications of the rules-based bot detector 304. Specifically, FIG. 6A illustrates an example application of a first rule 600 for a first user agent string 602 and a second user agent string 604. FIG. 6B illustrates an example application of a second rule 606 for a first IP address 608 and a second IP address 610.

In the example shown, the first rule 600 may be the following: For users having a common user agent string, if the ratio of visits to visitors (i.e., users) is less than a threshold (e.g., 1.005 or another number), and if none of the users are associated with a certain action (e.g., purchasing an item and thereby generating demand), then all the users associated with that user agent string are bots. In the example of FIG. 6A, a first user agent string 602 and a second user agent string 604 are identified as examples. Each of the user agent strings 602-604 are associated with activity data, which may correspond to users that provided the respective user strings to a component of the information system 102, such as the website 202.

In the example shown, for the user agent string 602, there are 388,145 users and 388,145 visits. Therefore, there were 388,145 users that are associated with the user agent string 602, and each of these users had one visit. As a result, the visit to visitor ratio is 1. Furthermore, the users associated with the user agent string 602 had zero demand. As a result, the rules-based bot detector 304 may identify the user agent string 602 as associated with bots. Therefore, the rules-based bot detector 304 may classify each of the 388,145 users associated with the user agent string 602 as bots and any subsequent users having the user agent string 602 as bots.

Continuing with the example 600 of FIG. 6A, the user agent string 604 may be associated with 37,316 users and 237,316 visits. Therefore, the visit to visitor ratio for users associated with the user agent string 604 is approximately 6.3. Furthermore, the user agent string is associated with a demand of $250. For example, the total demand generated by the 37,316 users associated with the user agent string 604 may be $250. In the example of FIG. 6A, because the visit to visitor ratio is over 1.005 or, alternatively, because the demand is greater than zero, the user agent string 604 and its associated users are not classified as bots by the rules-based bot detector.

In the example of FIG. 6B, the second rule 606 may be as follows: For users having a common IP address, if the visit to visitor ratio is less than a threshold (e.g., 1.005 or another number), and if none of the users are associated with a certain action (e.g., purchasing an item and thereby generating demand), then all the users associated with that IP address are bots. In the example of FIG. 6B, a first IP address 608 and a second IP address 610 are identified as examples. Each of the IP addresses 608-610 are associated with activity data, which may correspond to users that provided that communicate with the information system 102 form the respective IP addresses 608-610.

In the example shown, for the IP address, there are 31,979 users and 31,979 visits. Therefore, there are 31,979 users associated with the IP address 608, and each of these users had one visit. As a result, the visit to visitor ratio is 1. Furthermore, the users associated with the IP address 608 had zero demand. As a result, the rules-based bot detector 304 may identify the IP address 608 as associated with bots. Therefore, the rules-based bot detector 304 may classify each of the 31,979 users associated with the IP address 608 as bots and any subsequent users having the IP address 608 as bots.

Continuing with the example 606 of FIG. 6B, the IP address 608 may be associated with 9,192 users and 29,192 visits. Therefore, the visit to visitor ratio for users associated with the IP address 610 is approximately 3.1. Furthermore, the IP address 610 is associated with a demand of $300. For example, the total demand generated by the 9,192 users associated with the IP address 610 may be $300. In the example of FIG. 6B, because the visit to visitor ratio is over 1.005 or, alternatively, because the demand is greater than zero, the IP address 610 and its associated users are not classified as bots by the rules-based bot detector.

The rules-based bot detector 304 may apply different rules than those illustrated by the examples 600 and 606. As an example, the rules-based bot detector 304 may not require that demand be zero in order to classify a user agent string or IP address as being associated with a bot. For example, if the visit to visitor ratio for a user agent string or IP address is sufficiently close to 1, then that user agent string and user agent string may be classified as being associated with a bot irrespective of the demand. As another example, a different threshold visit to visitor ratio may be applied or a different threshold level of demand may be applied. Furthermore, as another example a different action, rather than demand or in addition to demand, may also be applied. In these and other ways, the rules-based bot detector 304 may be defined to detect bots in a manner that is customized to the website, application, or other component that is being monitored.

In some embodiments, various optimizations may be performed by the rules-based bot detector 304. As an example, for a given rule, such as the rule 600, the rules-based bot detector 304 may analyze only a certain number of entries in the activity data, because there may be thousands, tens of thousands, hundreds of thousands, or millions of data entries in the activity data. For example, the rules-based bot detector 304 may select an X number (e.g., 5) of user agent strings to classify as bots, if these user agent strings meet the conditions defined by the rule, based on these user agent strings having a high number of users associated therewith. Other optimizations are likewise possible.

FIG. 7 is a flowchart of an example method 700 for extracting features to be analyzed by the outlier bot detector 306. As described herein, the feature extractor 308 performs the operations of the method 700. However, one or more other components of the information system 102 may perform one or more operations of the method 700. In some embodiments, the feature extractor 308 may perform aspects of the method 700 prior to the outlier bot detector 306 analyzing activity data, and the feature extractor 308 may provide a list of the selected features to the outlier bot detector 306 after the feature extractor 308 has selected the features. In some embodiments the feature extractor 3098 may provide the selected to a different component as well. In some embodiments, the feature extractor 308 periodically reperforms operations of the method 700, resulting in a different set of features that may be used by the outlier bot detector 306.

In the example shown, the feature extractor 308 may create a bot dataset (operation 702). This may include retrieving previous bot classifications form the bot detector 104, or from another system, and activity data associated with those bot classifications. In some embodiments, creating a bot dataset may include retrieving data analyzed by one or more of the self-identified bot detector 302 or the rule-based bot detector 304 and a classification output by these bot detectors. In some embodiments, creating a bot dataset may include receiving an input from a human that labels activity data as corresponding to a bot or a human. In some embodiments, the bot dataset is organized by one or more of user identifier or time. In some embodiments, the bot dataset includes activity data associated with each user identifier. In some embodiments, the activity data includes a variety of types of data, which may include binary or non-binary data.

In the example shown, the feature extractor 308 may identify relevant features (operation 704). The relevant features may include a first subset of features of features in the activity data that may be relevant to identifying bot behavior. In some embodiments, the relevant features may be defined by a human. In some embodiments, at least some of the relevant features may be identified by a machine learning model. In some embodiments, the relevant features may include all features in the activity data. In some embodiments, the relevant features may include data exchanges between a user and one or more of the website 202 or service 204. In some embodiments, the relevant features may include data related to multiple sessions of a user with components of the information system 102. In some embodiments, the relevant features may include user attributes, such as a number of IDs, IP addresses, or browsers associated with the user. In some embodiments, the relevant features may include application-specific actions or attributes. For example, for the embodiment in which the information system 102 is associated with a retailer, the relevant features may include features related to item orders or to browsing items. However, in different embodiments, there may be different domain-specific features. For example, in the context of a digital media system, the features may include interactions with the digital media.

In the example shown, the feature extractor 308 may select features (operation 706). In some embodiments, the feature extractor 308 may select features from the identified relevant attributes. The selected features may be a subset of the relevant features. In some embodiments, the feature extractor 308 may select a subset of features that are most predictive of whether a user is a bot. Furthermore, the feature extractor 308 may select features based at least in part on the extent to which the features overlap. In some embodiments, the feature extractor 308 may perform a cross correlation analysis of the relevant features and select a subset of features such that a correlation across selected features is not greater than a pre-determined threshold. Once the features 708 are selected, the feature extractor 308 may provide the features 708 to the outlier bot detector 306. For example, the feature extractor 308 may provide a list or schema to the outlier bot detector 306, such that, when the outlier bot detector 306 receives subsequent activity data to analyze, the outlier bot detector 306 may evaluate values that correspond to the features 708.

In some embodiments, one or more of the selected features may be selected by a human based at least in part on domain expertise. In some embodiments, two or more features may be selected (or not selected) as a pair. For example, it may be identified that, if both of a set of features are present for a user, then there is a higher likelihood that the user is a bot. In some embodiments, a machine learning model may be used to select features. In some embodiments, a combination of feature selection techniques may be implemented. The number of selected features may depend on the embodiment.

In the example shown, the features 708 may include user attributes 710. These features may include characteristics of a given user. In the example shown, the user attributes 710 include the following: a number of IP addresses, which may be a number of IP addresses associated with the user in a day; a number of browsers, which may be a number of browsers or user agents associated with a user in a day; and number of profile identifiers, which may be number of identifiers associated with the user. The profile identifiers may be, for example, identifiers associated with the website 202, such as an account number that is associated with website 202.

The features 708 may include order metrics 712, which may user activity related to ordering items. In the example shown, the order metrics 712 include a demand, which may be a dollar amount associated with items purchased by a user. In some embodiments, however, a demand may be determined in a different manner. For example, the demand may be a number of items selected by a user, or it may be another metric of interest to an entity associated with the information system 102. The order metrics 712 further include the following: a number of cart adds, which may be a number of items added to a digital shopping cart or a number of times that a user performed an action for adding items to a digital shopping cart; and a number of visits, which may be a number of unique sessions for the user in day.

The features 708 may include browse metrics 714, which may relate to actions by the user as the user navigates the website 202. In the example shown, the browse metrics 714 include the following: an average visit time, which may be an average number of minutes per session in a day; a sum visit time, which may be the total minutes spent across all sessions in a day for a user; a median visit time, which may be the median number of minutes per session in a day for a user; a number of views, which may be the number of times in which any web pages or other visual components of the website 202 are viewed, in which the same web page may be viewed multiple times; a number of pages, which may be the number of web pages visited in a day, in which each web page may only be counted once; a number of product page views, which may be the number of times that web pages for a particular items are viewed; a number of home page views; a number of non-character searches, which may be the number of times that the user used a search feature and the search terms included non-character terms, which may be item IDs for which bots are programmed to search; a number of search page views; a number of level 3 page views, which may be associated with a third level of granularity in an item hierarchy that includes at least a category level, a subcategory level, and an item level; and a number of null previous page views, which may be a number of views in which the previous page was null. In an example, the features identified in the features 708 may be used by the outlier bot detector 306 for identifying bot users.

FIG. 8 is a flowchart of an example method 800 for detecting outlier bots. As described herein, at least some operations of the method 800 may be performed by the outlier bot detector 306. However, in some embodiments, one or more operations of the method 800 may be performed by a different component of the information system than the outlier bot detector 306. In some embodiments, aspects of the method 800 may be performed as part of performing the operation 410 of FIG. 4.

In the example shown, the outlier bot detector 306 may receive activity data (operation 802). In some embodiments, this may include the same activity data received by the bot detector 104 at the operation 402 of FIG. 4. In some instances, the activity data may be for a previous day and may be associated with users of the website 202. In some embodiments, one or more of the users of the activity data may have been classified by one or more of the self-identified bot detector 302 or the rules-based bot detector 304 as bots. In some embodiments, one or more of the users may have been identified as a single-page user.

In the example shown, the outlier bot detector 306 may identify extracted features (operation 804). In some embodiments, this may include receiving extracted features from the feature extractor 308. In some embodiments, the outlier bot detector 306 may, for each of the features identified by feature extractor 308, determine values for the feature from the user activity data. For example, referring to the example features 708 of FIG. 7, for a given user, the outlier bot detector 306 may determine, for example, the number of IP addresses associated with the user, the number of browsers associated with the user, the number of profile IDs associated with the user, the demand associated with the user, and so on for each feature identified by the feature extractor 308.

In the example shown, the outlier bot detector 306 may filter the activity data (operation 806). Filtering the activity data may include applying a filter to the received activity data or may include supplementing, converting, pruning, dividing, organizing, or otherwise preparing the data for input into one or more outlier detection models.

As an example of filtering the data, the outlier bot detector 306 may filter out single-page users, or single-page visitors. The single page users may be users that only visited one page of the website 202 in a day or, in some embodiments, in a session. In some embodiments, because single-page users may be numerous relative to users that visited multiple pages, they may skew the results of outlier detection models if considered together with users that visited multiple pages. As another example filtering the activity data, the outlier bot detector 306 may separate users with demand from users without demand. As other example filters, the outlier bot detector 306 may separate users based on other features.

The outlier bot detector 306 may apply one or more outlier detection models to the activity data. In some embodiments, the outlier bot detector 306 may apply an ensemble of outlier detection models. The outlier detection models may include one or more of a Z-Score model, an interquartile range (IQR) model, and a clustering model. In some embodiments, these models may be applied in parallel, whereas in other embodiments, they may be applied sequentially. In some embodiments, fewer models may be applied. In some embodiments, one or more of the models may be combined. In some embodiments, additional models or a different set of models may be applied. For example, in some instances, a Principal Component Analysis model may be applied.

In some embodiments, one or more of the outlier detection models may be applied multiple times for a given set of activity data. For example, as described in connection with the operation 806, the outlier bot detector 306 may filter the activity data and may thereby, in some instances, create groups, such as a group of users with demand and a group of users without demand, or a group of single-page viewers and a group of user that visited multiple pages. In some embodiments, the outlier detection models may be applied to separate groups. For example, the outlier bot detector 306 apply one or more of a Z-Score model, IQR model, or clustering model to a group of users with demand and then separately apply the one or more of the Z-Score model, IQR model, or clustering model to a group without demand. As such, the outlier bot detector 306 may more accurately identify outliers within each group. In some embodiments, the outlier bot detector 306 may ignore certain groups of users. For example, the outlier bot detector 306 may not apply outlier detection models to single-page users, a decision that may increase the overall speed of detecting outlier bots (because there may be many single-page users) and a decision that may not significantly reduce the effectiveness of the bot detector 104, since it may be more efficient or accurate to determine whether single-page viewers are bots using another component.

In some embodiments, each of the outlier detection models may, for a given user for a given day, generate a score, which may be a bot confidence score for that outlier detection model. In some embodiments, the higher the score, the more likely the user is a bot, according to the outlier detection model that generated the score. The outlier bot detector 306 may weight and aggregate the scores from different models as part of determining whether to classify the user as a bot.

In the example shown, the outlier bot detector 306 may apply a Z-Score model (operation 808). Applying the Z-Score model may generate a score for a user based on differences between feature values for the user from average feature values for a group of users provided to the Z-Score model. In some embodiments, as part of applying the Z-Score model, the outlier bot detector 306 determines a mean and standard deviation for each identified feature from the feature extractor 308 (e.g., the outlier bot detector 306 determines that the mean value for the feature “number of pages viewed” is 3). In some embodiments, this mean and standard deviation may be determined by using activity data associated with users that are being evaluated by the Z-Score model. In some embodiments, however, the mean and standard deviation may at least in part be determined based on historical user activity data, which may include activity data of users that are not currently being evaluated.

In some embodiments, having determined a mean and standard deviation, the outlier bot detector 306 may determine whether a user's value for the feature is beyond three standard deviations from the mean. If so, the outlier bot detector 306 flags that feature for that user. For a given user, the output of the Z-Score model is the number of flagged features over the number of features. For example, for a given user, if the outlier bot detector 306 flagged 5 features as being beyond three standard deviations from the mean, and if there are 10 features, then the score output by the Z-Score model may be 0.5.

Variations of the Z-Score model are possible. For example, rather than using flags that signify whether, for a given feature, a user is or is not more than three standard deviations from the mean, the Z-Score model may consider the degree to which a user is or is not beyond three standard deviations from a mean value. As such, a user having a feature value that is four standard deviations from a mean may be scored higher than a user having a feature value that is three standard deviations from the mean. Additionally, in some embodiments, the Z-Score model may weigh some features higher than others. For example, if a user is beyond three standard deviations from a mean for a feature that is shown to be more predictive of bot behavior, then this user may be scored higher than if the user was higher than three standard deviations from a mean for a feature that is less predictive of bot behavior. Additionally, the Z-Score model may use a different number of standard deviations than three as part of identifying bot behavior. Other variations of the Z-Score are likewise possible as part of identifying anomalous user behavior based on distance from a mean.

In the example shown, the outlier bot detector 306 may apply the IQR model (operation 810). In some embodiments, the IQR model may work similar to the Z-Score model and the scoring, variations, and other features described in connection with the Z-Score model may likewise be applicable to the IQR model. However, rather than using mean as a center value and standard deviation (as in the Z-Score model), applying the IQR model may include determining a median and interquartile range (e.g., a distance between quartile 1 and quartile 3 for values of a feature). Then for a given user and given feature, if the user's value for that feature is more or less than three interquartile ranges from the median, then that feature is flagged. For a given user, the score output by the IQR model may be the number of flagged features over the number of features. However, as described in connection with the Z-Score model, there may be variations to the IQR model. In some embodiments, each of the Z-Score model and the IQR model may evaluate the same set of features, which may, in some embodiments, be all of the features identified by the feature extractor 308. However, in some embodiments, the feature sets may vary between the Z-Score model and the IQR model, and more or fewer features than those identified by the feature extractor 308 may be evaluated.

In the example shown, the outlier bot detector 306 may apply a clustering model 812. Applying the clustering model may include grouping the users into clusters based on values for features. In some embodiments, to improve computational speed and to reduce noise, a subset of the features identified by the feature extractor 308 is used to generate clusters. Having generated the clusters, each of the users may belong to a cluster, which may have a center, or a centroid. If a user is sufficiently far away from the center of its cluster, then the user may be scored as a bot (e.g., the user may be assigned a score of “1”). If, however, the user is not sufficiently far away from the center of its cluster, the user may not be scored as a bot (e.g., the user may be assigned a score of “0”). In some embodiments, distance is measured using a cosine distance or Euclidean distance using values of features. In some embodiments, the users that are in the 99th percentile (or a different percentile) with respect to distance from a center (e.g., users that are further away from a cluster center than 99% of other users assigned to that cluster) are determined to be sufficiently far away from a cluster center and therefore scored as a bot.

In some embodiments, the scoring of users based on a clustering model may vary. For example, rather than applying a binary scoring of users of “1” or “0” a sliding score scale may be applied to a user based on a distance from a centroid. For example, as a user is further away from the centroid of a cluster, its score increases, either continuously or incrementally, from “0” to “1”. In some embodiments, rather than scoring a user based on a distance to a center relative to distances to a center of other users, a score for a user may be determined based at least in part on the distance measurement itself.

Various clustering models are possible. In some embodiments, the clustering model is unsupervised, whereas in other embodiments, the clustering model may be supervised or semi-supervised model. In some embodiments, a k-means clustering algorithm is used. In some embodiments, a different clustering model is used, such as, for example, variations to k-means clustering, DBSCAN (Density-Based Spatial Clustering of Applications with Noise), deep learning models, or other clustering models.

In the example shown, the outlier bot detector 306 may weigh and aggregate scores (operation 814). For example, the outlier bot detector 306 may receive scores from one or more outlier detection models, such as one or more of the Z-Score model, IQR model, or clustering model. In some embodiments, each outlier model that is used may output a score for one or more of the users. In some embodiments, each of the scores is between 0 and 1, where the higher the value, the higher likelihood assigned by the model of the user being a bot. In some embodiments, each of the models may normalize a score such that the score is between 0 and 1.

In some embodiments, the outlier bot detector 306 may assign a weight to each of the outlier detection models. In some embodiments, the outputs for the models may be weighed equally. Therefore, if three outlier detection models are used, as in the example of FIG. 8, then each of the models may be assigned a weight of 0.33. If four models were used, then each would be assigned a weight of 0.25. If only two models were used, or only two models generated a score for a particular user, then the each of the models would be assigned a weight of 0.5. In some embodiments, the outlier bot detector 306 may weigh some models greater than others. For example, each of the Z-Score model and the IQR model could be assigned a weight of 0.4, and the clustering model could be assigned a weight of 0.2. Other variations are likewise possible. In some embodiments, the weights are determined based on historical performance data. For example, based on the results of a validation of previous bot classifications, the outlier bot detector 306 may alter the weights assigned to the outlier detection models to improve the accuracy of bot detection.

In some embodiments, for a given user, after applying a weight to the output of each outlier detection model, the outlier bot detector 306 may aggregate the weighted scores. For example, the outlier bot detector 306 may add the weighted scores. By adding and weighing scores, the outlier bot detector 306 may determine a bot confidence score for each of the users. The bot confidence score may be a value between 0 and 1. An example of weighing and aggregating scores from the outlier detection models is illustrated and described in connection with FIG. 9.

In the example shown, the outlier bot detector 306 may classify users (operation 816). In some embodiments, the outlier bot detector 306 may, for each user, use a bot confidence score determined for the user at the operation 814. In some embodiments, the outlier bot detector 306 may compare the bot confidence score with a threshold value. If the bot confidence score is greater than (or greater than or equal to) the threshold value, the user is classified as a bot. If the bot confidence score is less that (or, in some embodiments, less than or equal to) the threshold value, then the user is not classified as a bot. In some embodiments, the threshold value is pre-determined.

Depending on the embodiments, the threshold value may vary. In some embodiments, the threshold value is set such that at least two of the outlier detection models must output at least a moderate score (e.g., at least above 0.5) for the user to be classified as a bot. An example threshold value is 0.42. In some embodiment, the threshold value is set based on a validation of previously identified bots. For example, the threshold value may be set at a point such that it is expected, based on past data, that a sufficient percentage of outlier bots would be detected (e.g., at least 90%). In some embodiments, the threshold value is set such that only a certain percentage of users can be classified as outlier bots. In some embodiments, the threshold value is set such that decreasing the threshold any further would result in a marginal increase of bot detection that is determined to be insufficient given a higher likelihood of falsely identifying a user as a bot. In some embodiments, different threshold values may be used for different groups of users. For example, a group of users associated with demand may have a higher threshold value than a group of users without demand. In some embodiments, the threshold value may be dynamically set based on characteristics of a set of activity data or based on a user input.

In some embodiments, the outlier bot detector 306 may classify users as bots or not as bots by using techniques instead of or in addition to comparing a bot confidence score with a threshold value. For example, in some instances, the outlier bot detector 306, or another component of the bot detector 104 may automatically classify a user as a bot if a different bot detector (e.g., the self-identified bot detector 302 or the rules-based bot detector 304) classified the user as a bot. This classification as a bot may occur even if the bot confidence score generated by the outlier bot detector 306 is less than a threshold. In some embodiments, an administrator associated with the information system 102, or another component of the information system 102, may override a classification (e.g., an administrator may manually enter whether a user is a bot), and based on the override, the bot may be classified as a bot or not a bot. An example of classifying users is illustrated and described in connection with FIG. 9.

FIG. 9 is a flowchart of an example 900 of certain aspects of the method 800 of FIG. 8. In the example of FIG. 9, example outputs 902, 904, and 906 are output by the Z-Score model, IQR model, and clustering model, respectively. Each of the outputs includes data for three users associated with the user IDs 101, 102, and 103. As described in connection with FIG. 8, each of the outlier detection models may have been provided activity data for users associated with the IDs 101-103. The numbers illustrated in the example of FIG. 9 are for example purposes.

The Z-Score model output 902 is a table in which each user corresponds to a row. In the example of FIG. 9, the Z-Score model evaluates 17 features (e.g., the features 708 of FIG. 7) to determine whether a user is an outlier. If, for a feature, a user is an outlier (e.g., at least 3 standard deviations away from a mean value for that feature), then that feature is flagged. In the example shown, the Z-Score model flagged 10 features for the user associated with the ID 101, 2 features for the user associated with the ID 102, and 8 features for the user associated with the ID 103. In the example shown, the score output by the Z-Score model for each of the users is the number of flags divided by the number of features. In a similar manner, the IQR model output 904 is a table in which features are flagged for a user based on, for example, whether the values for a feature are more than three interquartile ranges away from a standard deviation. As shown, the score for the IQR model may be a number of flags over a number of features.

The clustering model output 906 includes a table in which each of the users is assigned a score of 1 or 0 based on the cluster flag. The cluster flag for a user may be set to 1 if the user is sufficiently far from a center of cluster with which the user is grouped, as described in connection with FIG. 8.

In the example shown, the outlier bot detector 306 may weigh and aggregate the scores of the outputs 902-906, as depicted by the operation 814, which is described in connection with FIG. 8. In the example shown, the outputs may be weighed equally, so the scores in each of the outputs 902-906 may be multiplied by 0.333. Furthermore, the scores may be aggregated by adding the weighted scores. As a result, the combined output of the outlier detection models may be the following: 0.842 for the user associated with user ID 101; 0.059 for the user associated with the user ID 102; and 0.369 for the user associated with the user ID 103. these scores may represent example respective bot confidence scores for the respective users.

In the example shown, the outlier bot detector 306 may classify users, as depicted by the operation 816, which is described in connection with FIG. 8. For example, the outlier bot detector 306 may compare the bot confidence scores for each of the users to a threshold value (e.g., 0.42 or another value) to determine whether the user is a bot. Additionally, if a user is determined to be a self-identified bot or a rules-based bot, then the determination may also be applied as part of classifying bots. In the example shown, the classification 908 illustrates classifications for the example users of FIG. 9. The user associated with the ID 101 is classified as an outlier bot, since the bot confidence score generated by the outlier detection models is greater than a threshold, the user associated with the user ID is determined to not be a bot, and the user associated with the user ID is determined to be a self-identified bot. For example, the self-identified bot detector 302 may have identified the user 103 as a bot, and therefore, the bot confidence score for the user 103 may be adjusted to “1”.

FIG. 10 illustrates an example user interface 1000. In some embodiments, the user interface 1000 may be part of an application that belongs to the information system 102. The application may include aspects of the analytics system 210, the report generator 310, additional user interfaces, and other components described herein. In some embodiments, the user interface 1000 is communicatively coupled with the bot detector 104. The user interface 1000 may enable a user to configure settings of the bot detector 104. The user interface 1000 may also receive output from the bot detector 104 and may use the output to generate visualizations, reports, and other output. In some embodiments, an administrator, analyst, engineer, or other person associated with the information system 102 may have access to the user interface 1000. In the example shown, the user interface 1000 includes various regions, each of which includes one or more functions or displays provided via the user interface 1000. The user interface may include more or fewer components than those described in connection with FIG. 10.

The bot detector selection region 1002 includes inputs fields that enable an administrator to select from among subsystems that are to be used as part of the bot detector 104. In the example shown, the administrator may select one or more of the self-identified bot detector, the rules-based bot detector, or the outlier bot detector. In some embodiments, the bot detector may use only those bot detectors that are selected by the administrator. Furthermore, the administrator may be able to configure settings for one or more of the bot detectors. For the self-identified bot detector 302, such settings may include whether to use a keyword matching system and/or a machine learning model, a selection of keywords to use, and other characteristics of the self-identified bot detector. For the rules-based bot detector 304, the administrator may define rules that are to be applied, may select from among a plurality of potential rules to apply, and select other characteristics associated with the rules-based bot detector. For the outlier bot detector 306, the administrator may select one or more outlier detection models to be used (along with configurations for one or more of the selected outlier detection models), may select features to be analyzed, may select threshold values, and may select other characteristics associated with the outlier bot detector. In some embodiments, the administrator may further define the time at which the bot detector 104 is to be executed and may select the computer systems to be used to execute the bot detector.

The parameters region 1004 includes one or more input fields for a user to select one or more of a date or date range and time of activity data to be analyzed for bots, a data source that is to be used, and an application to be monitored. In some embodiments, the application to be monitored is a website, or a particular web page or feature of the website.

The visualization creation region 1006 includes one or more options to create visualizations that include data output by the bot detector 104. In some instances, a visualization may be part of a dashboard. A dashboard may be displayed on a graphical user interface and may include input fields and one or more cards. A card may include a data visualization. A data visualization may include one or more of a graph, chart, table, or explanatory text. In some embodiments, the visualization creation region 1006 enables a user to create one or more of dashboard or a card that may include data output by the bot detector 104 or another component of the information system 102. An example visualization in such a dashboard or card may include one or more of the following: a number or percentage of users classified as bots; a bot confidence score for one or more users; an identification of which bot detector subsystem was used to classify a given user as a bot; an indication of activity performed by a detected bot; a flag or description of any anomalies; a result of a validation; one or more input fields for interacting with the output data; and other example components.

The output region 1008 may include data visualizations and input fields for interacting with the data. The output region 1008 may include visualizations created using the visualization creation region 1006 and using inputs received from the bot detector selection region 1002 and the parameters region 1004. In the example shown, the output region 1008 includes a pie chat (e.g., showing a portion of users classified as bots or a portion of each type of bot); a bar graph; a scatter plot (e.g., showing features of user activity and a classification of whether a user is a bot); and a data table. Furthermore, the output region 1008 includes one or more input fields for performing one or more of interacting with the data visualizations, performing a validation (e.g., using the validation system 312), publishing the data to another system (e.g., sharing or exporting data from the bot detector 104); and downloading the data. The user interface 1000 may include more or fewer components than those illustrated in connection with FIG. 10.

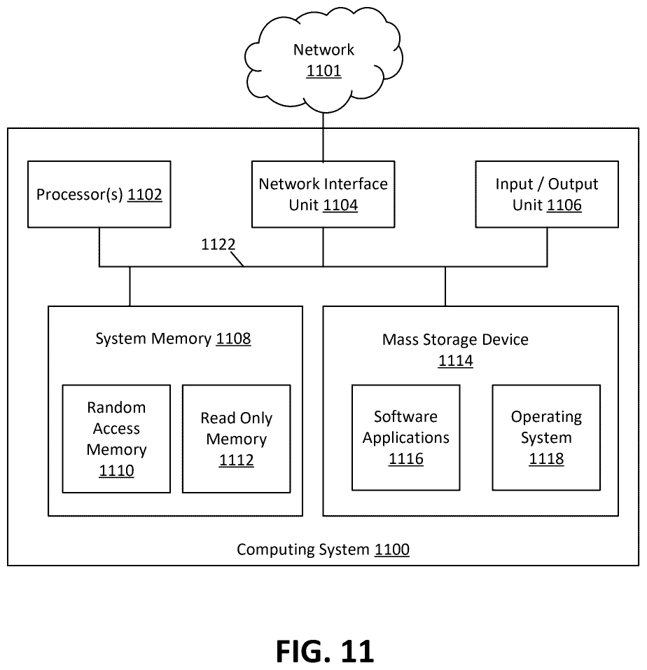

FIG. 11 illustrates an example block diagram of a virtual or physical computing system 1100. One or more aspects of the computing system 1100 can be used to implement the system and processes described herein.

In the embodiment shown, the computing system 1100 includes one or more processors 1102, a system memory 1108, and a system bus 1122 that couples the system memory 1108 to the one or more processors 1102. The system memory 1108 includes RAM (Random Access Memory) 1110 and ROM (Read-Only Memory) 1112. A basic input/output system that contains the basic routines that help to transfer information between elements within the computing system 1100, such as during startup, is stored in the ROM 1112. The computing system 1100 further includes a mass storage device 1114. The mass storage device 1114 is able to store software instructions and data. The one or more processors 1102 can be one or more central processing units or other processors.

The mass storage device 1114 is connected to the one or more processors 1102 through a mass storage controller (not shown) connected to the system bus 1122. The mass storage device 1114 and its associated computer-readable data storage media provide non-volatile, non-transitory storage for the computing system 1100. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1100.

According to various embodiments of the invention, the computing system 1100 may operate in a networked environment using logical connections to remote network devices through the network 1101. The network 1101 is a computer network, such as an enterprise intranet and/or the Internet. The network 1101 can include a LAN, a Wide Area Network (WAN), the internet, wireless transmission mediums, wired transmission mediums, other networks, and combinations thereof. The computing system 1100 may connect to the network 1101 through a network interface unit 1104 connected to the system bus 1122. It should be appreciated that the network interface unit 1104 may also be utilized to connect to other types of networks and remote computing systems. The computing system 1100 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 1114 and the RAM 1110 of the computing system 1100 can store software instructions and data. The software instructions include an operating system 1118 suitable for controlling the operation of the computing system 1100. The mass storage device 1114 and/or the RAM 1110 also store software instructions, that when executed by the one or more processors 1102, cause one or more of the systems, devices, or components described herein to provide functionality described herein. For example, the mass storage device 1114 and/or the RAM 1110 can store software instructions that, when executed by the one or more processors 1102, cause the computing system 1100 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the components and operations shown and described above.

This disclosure described some aspects of the present technology with reference to the accompanying drawings, in which only some of the possible aspects were shown. Other aspects can, however, be embodied in different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, operations can be repeated, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A method for detecting bots, the method comprising:
receiving activity data associated with a website;
identifying a first set of bots in the activity data by identifying self-identifying bots;
identifying a second set of bots in the activity data by applying one or more rules for identifying bots; and
identifying a third set of bots in the activity data by identifying outlier activity.

2. The method of claim 1, wherein identifying the third set of bots in the activity data by identifying outlier activity comprises:
applying one or more models to generate a plurality of bot confidence scores for a plurality of users in the activity data; and
for each user of the plurality of users, comparing a respective bot confidence score of the plurality of bot confidence scores to a threshold value.

3. The method of claim 1, wherein identifying the third set of bots in the activity data by identifying outlier activity comprises, for each user of a plurality of users in the activity data:
for each feature of a plurality of features, identifying a feature value for the user;
for each feature of the plurality of features, flagging the feature in response to determining that the feature value for the user is more than a distance from a center value;
determining a score based in part on a number of flagged features; and
in response to determining that the score is greater than a threshold, identifying the user as a bot.

4. The method of claim 1, wherein identifying the third set of bots in the activity data by identifying outlier activity comprises, for each user of a plurality of users in the activity data:
generating a first score for the user by applying a statistical model;
generating a second score for the user by applying a clustering model;
weighing and aggregating at least the first score and second score to generate a bot confidence score; and
based on the bot confidence score, determining whether to classify the user as a bot.

5. The method of claim 1, wherein identifying the third set of bots in the activity data by identifying outlier activity comprises:
applying a Z-Score model to determine, for a first feature, a first distance between a first value for a user and a mean value for the first feature;
applying an interquartile range model to determine, for a second feature, a second distance between a second value for the user and a median value for the second feature;
applying a clustering model to cluster a plurality of users in the activity data; and
determining a third distance between the user and a center of a cluster to which the user is assigned.

6. The method of claim 1, wherein identifying the third set of bots in the activity data by identifying outlier activity comprises:
identifying a plurality of features; and
for each user of a plurality of users in the activity data, determining whether the user is an outlier based on values of the plurality of features for the user;
wherein the plurality of features comprises a demand and a number of product page views.

7. The method of claim 1, wherein identifying the third set of bots in the activity data by identifying outlier activity comprises:
providing at least some of the activity data to an outlier detection model; and
prior to providing the at least some of the activity data to the outlier detection model, filtering out users that only visited a single page of the website.

8. The method of claim 1, wherein the activity data includes a plurality of users that visited the website during a previous day.

9. The method of claim 1, further comprising, generating a visualization, the visualization displaying:
at least some of the activity data;
an indication, for at least some users of a plurality of users in the activity data, whether the user belongs to the first set of bots, the second set of bots, or the third set of bots; and
for at least some bots of the third set of bots, a bot confidence score generated by an outlier detection model.

10. The method of claim 1, wherein identifying the self-identified bots comprises:
identifying one or more keywords in user agent strings for users in the activity data; and
applying a machine learning model to the user agent strings.

11. The method of claim 1, wherein applying the one or more rules for identifying bots comprises:
identifying a plurality of users associated with an IP address or a user agent string;
determining a visits to visitors ratio for the plurality of users;
determining a demand for the plurality of users; and
based on the visits to visitors ratio and based on the demand, determining that all users associated with the IP address or the user agent string are bots.

12. A method for identifying bots based on outlier activity, the method comprising:
receiving activity data associated with a website, the activity data including a plurality of users;
identifying a plurality of features;
inputting the activity data into a first model to generate a first score for each user of the plurality of users, wherein the first model determines center values for the plurality of features and generates the first score for each user based on distances of feature values for the user from the center values for the plurality of features;
inputting the activity data into a second model to generate a second score for each user of the plurality of users, wherein the second model clusters the plurality of users and generates the second score for each user based on a distance of the user from a center of a cluster to which the user is assigned;
for each user of the plurality of users, aggregating the first score and the second score for the user to determine whether the user is an outlier; and
for each user of the plurality of users, in response to determining that the user is an outlier, classifying the user as a bot.

13. The method of claim 12, wherein inputting the activity data into the first model to generate the first score for each user of the plurality of users comprises, for each user of the plurality of users:
for each feature of the plurality of features, flagging the feature in response to determining that a feature value for the user is greater than a range from a center value for the feature; and
generating the first score based at least in part on a number of flagged features.

14. The method of claim 12, wherein aggregating the first score and the second score comprises equally weighing the first score and the second score.

15. The method of claim 12,
wherein the first model includes a Z-Score model and an interquartile range model;
wherein the first score comprises an aggregation of a score output by the Z-Score model and a score output by the interquartile range model; and
wherein the second model is an unsupervised machine learning model.

16. The method of claim 12, wherein aggregating the first score and the second score for the user to determine whether the user is an outlier comprises comparing the aggregation of the first score and the second score to a predetermined threshold.

17. The method of claim 12,
further comprising prior to inputting the activity data into the first model and prior to inputting the activity data into the second model, separating the plurality of users into a first group and a second group, wherein the first group is associated with demand and wherein the second group is not associated with demand;
wherein inputting the activity data into the first model comprises separately inputting activity data for the first group and the second group; and
wherein inputting the activity data into the second model comprises separately inputting activity data for the first group and the second group.

18. A system for detecting bots, the system comprising:
a website;
an activity detector configured to determine activity data associated with the website; and
a bot detector;
wherein the bot detector includes a processor and memory storing instructions, wherein the instruction, when executed by the processor, cause the bot detector to:
identify a first set of bots in the activity data by identifying self-identifying bots;
identify a second set of bots in the activity data by applying one or more rules for identifying bots; and
identify a third set of bots in the activity data by identifying outlier activity.

19. The system of claim 18, further comprising an analytics system configured to:
receive, from the bot detector, bot classifications and at least some of the activity data; and
display a visualization including the bot classifications.

20. The system of claim 18, wherein the website is a retail website.
